(19) United States
(12) Patent Application Publication
(10) Pub. No.: US 2010/0069070 A1
(43) Pub. Date: Mar. 18, 2010

(54) LOCATION-ASSISTED NETWORK ENTRY, SCAN AND HANDOVER

(75) Inventors: Guangming Carl Shi, San Diego, CA (US); Kuo-Chun Lee, San Diego, CA (US); Tom Chin, San Diego, CA (US); Isaac Ta-yan Siu, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/211,859

(22) Filed: Sep. 17, 2008

(51) Int. Cl. H04W 36/00; H04W 64/00

(52) U.S. Cl. 455/436; 455/456.5

(57) ABSTRACT

Methods and apparatus for using a location of a mobile station (MS) to assist network entry and initialization, scanning, and/or handover operations in a radio access technology (RAT), such as WiMAX (Worldwide Interoperability for Microwave Access), are provided. The location of the MS may be ascertained by determining the Global Positioning System (GPS) coordinates of the MS internally or by receiving the location from a GPS device external to the MS. Knowledge of the current or future location of the MS may reduce the amount of base station (BS) information transmitted to the MS; may reduce the power consumption and the amount of time spent during network entry, scanning, or handover; and may increase the bandwidth usage efficiency.

### TECHNICAL FIELD

Certain embodiments of the present disclosure generally relate to wireless communications and, more particularly, to using a location of a mobile station (MS) to assist network entry and initialization, scanning, and/or handover operations.

### BACKGROUND

Orthogonal frequency-division multiplexing (OFDM) and orthogonal frequency division multiple access (OFDMA) wireless communication systems under IEEE 802.16 use a network of base stations to communicate with wireless devices (i.e., mobile stations) registered for services in the systems based on the orthogonality of frequencies of multiple subcarriers and can be implemented to achieve a number of technical advantages for wideband wireless communications, such as resistance to multipath fading and interference. Each base station (BS) emits and receives radio frequency (RF) signals that convey data to and from the mobile stations.

For various reasons, such as a mobile station (MS) moving away from the area covered by one base station and entering the area covered by another, a handover (also known as a handoff) may be performed to transfer communication services (e.g., an ongoing call or data session) from one base station to another. Three handover methods are supported in IEEE 802.16e-2005: Hard Handoff (HHO), Fast Base Station Switching (FBSS) and Macro Diversity Handover (MDHO). Of these, supporting HHO is mandatory, while FBSS and MDHO are two optional alternatives.

HHO implies an abrupt transfer of connection from one BS to another. The handover decisions may be made by the MS or the BS based on measurement results reported by the MS. The MS may periodically conduct an RF scan and measure the signal quality of neighboring base stations. The handover decision may arise, for example, from the signal strength from one cell exceeding the current cell, the MS changing location leading to signal fading or interference, or the MS requiring a higher Quality of Service (QoS). Scanning is performed during scanning intervals allocated by the BS. During these intervals, the MS is also allowed to optionally perform initial ranging and to associate with one or more neighboring base stations. Once a handover decision is made, the MS may begin synchronization with the downlink transmission of the target BS, may perform ranging if it was not done while scanning, and may then terminate the connection with the previous BS. Any undelivered Protocol Data Units (PDUs) at the BS may be retained until a timer expires.

When FBSS is supported, the MS and BS maintain a list of BSs that are involved in FBSS with the MS. This set is called a diversity set. In FBSS, the MS continuously monitors the base stations in the diversity set. Among the BSs in the diversity set, an anchor BS is defined. When operating in FBSS, the MS only communicates with the anchor BS for uplink and downlink messages including management and traffic connections. Transition from one anchor BS to another (i.e., BS switching) can be performed if another BS in the diversity set has better signal strength than the current anchor BS. Anchor update procedures are enabled by communicating with the serving BS via the Channel Quality Indicator Channel (CQICH) or the explicit handover (HO) signaling messages.

A FBSS handover begins with a decision by an MS to receive or transmit data from the anchor BS that may change within the diversity set. The MS scans the neighbor BSs and selects those that are suitable to be included in the diversity set. The MS reports the selected BSs, and the BS and the MS update the diversity set. The MS may continuously monitor the signal strength of the BSs that are in the diversity set and selects one BS from the set to be the anchor BS. The MS reports the selected anchor BS on CQICH or MS-initiated handover request message.

For MSs and BSs that support MDHO, the MS and BS maintain a diversity set of BSs that are involved in MDHO with the MS. Among the BSs in the diversity set, an anchor BS is defined. The regular mode of operation refers to a particular case of MDHO with the diversity set consisting of a single BS. When operating in MDHO, the MS communicates with all BSs in the diversity set of uplink and downlink unicast messages and traffic.

An MDHO begins when an MS decides to transmit or receive unicast messages and traffic from multiple BSs in the same time interval. For downlink MDHO, two or more BSs provide synchronized transmission of MS downlink data such that diversity combining is performed at the MS. For uplink MDHO, the transmission from an MS is received by multiple BSs where selection diversity of the information received is performed.

In addition to scanning for potential handover candidates due to, for example, weak signal strength of a serving BS, scanning may also be performed when an MS attempts to initially acquire a network or reacquire the network after a signal loss. The MS may begin to scan the possible channels of the downlink frequency band of operation until it finds a valid downlink signal. Once the MS has acquired a valid downlink signal from a BS, the network entry procedures may proceed with ranging, negotiation of basic capabilities, and registration as described in the IEEE 802.16 standard.

### SUMMARY

Certain embodiments of the present disclosure generally relate to using a location of a mobile station (MS) to assist network entry and initialization, scanning, and/or handover operations in such radio access technologies (RATs) as WiMAX (Worldwide Interoperability for Microwave Access). Knowledge of the current or future location of the MS may reduce the amount of base station (BS) information transmitted to the MS; may reduce the power consumption and the amount of time spent during network entry, scanning, or handover; and may increase the bandwidth usage efficiency.

Certain embodiments of the present disclosure provide a method for determining one or more neighbor BS candidates for an MS to scan or handover. The method generally includes transmitting a signal indicating a location of the MS and receiving a message comprising the one or more neighbor BS candidates selected, based on the location of the MS, from a plurality of neighbor base stations.

Certain embodiments of the present disclosure provide a computer-program product for determining one or more neighbor BS candidates for an MS to scan or handover, comprising a computer-readable medium having instructions stored thereon, the instructions being executable by one or more processors. The instructions generally include instructions for transmitting a signal indicating a location of the MS and instructions for receiving a message comprising the one or more neighbor BS candidates selected, based on the location of the MS, from a plurality of neighbor base stations.

Certain embodiments of the present disclosure provide an apparatus for determining one or more neighbor BS candidates for an MS to scan or handover. The apparatus generally includes means for transmitting a signal indicating a location of the MS and means for receiving a message comprising the one or more neighbor BS candidates selected, based on the location of the MS, from a plurality of neighbor base stations.

Certain embodiments of the present disclosure provide a mobile device. The mobile device generally includes a transmitter configured to transmit a signal indicating a location of the mobile device and a receiver configured to receive a message comprising one or more neighbor BS candidates selected, based on the location of the mobile device, from a plurality of neighbor base stations.

Certain embodiments of the present disclosure provide a method for advertising one or more neighbor BS candidates. The method generally includes receiving a signal indicating a location of the MS; based on the location of the MS, selecting the one or more neighbor BS candidates from a plurality of neighbor base stations; and transmitting a message comprising information about the one or more neighbor BS candidates.

Certain embodiments of the present disclosure provide a computer-program product for advertising one or more neighbor BS candidates, comprising a computer-readable medium having instructions stored thereon, the instructions being executable by one or more processors. The instructions generally include instructions for receiving a signal indicating a location of an MS, instructions for selecting the one or more neighbor BS candidates from a plurality of neighbor base stations based on the location of the MS, and instructions for transmitting a message comprising information about the one or more neighbor BS candidates.

Certain embodiments of the present disclosure provide an apparatus for advertising one or more neighbor BS candidates. The apparatus generally includes means for receiving a signal indicating a location of an MS, means for selecting the one or more neighbor BS candidates from a plurality of neighbor base stations based on the location of the MS, and means for transmitting a message comprising information about the one or more neighbor BS candidates.

Certain embodiments of the present disclosure provide a base station. The base station generally includes a receiver configured to receive a signal indicating a location of an MS, logic configured to select one or more neighbor BS candidates from a plurality of neighbor base stations based on the location of the MS, and a transmitter configured to transmit a message comprising information about the one or more neighbor BS candidates.

Certain embodiments of the present disclosure provide a method for determining priority of neighbor base station candidates for an MS to scan or handover. The method generally includes obtaining information about a plurality of neighbor BSs, the information including a location for each of the plurality of neighbor BSs, and prioritizing the plurality of neighbor BSs to scan or handover based on distances between the location for each of the plurality of neighbor BSs and the a location of the MS.

Certain embodiments of the present disclosure provide a computer-program product for determining priority of neighbor base station candidates for an MS to scan or handover, comprising a computer-readable medium having instructions stored thereon, the instructions being executable by one or more processors. The instructions generally include instructions for obtaining information about a plurality of neighbor BSs, the information including a location for each of the plurality of neighbor BSs, and instructions for prioritizing the plurality of neighbor BSs to scan or handover based on distances between the location for each of the plurality of neighbor BSs and a location of the MS.

Certain embodiments of the present disclosure provide an apparatus for determining priority of neighbor base station candidates for an MS to scan or handover. The apparatus generally includes means for obtaining information about a plurality of neighbor BSs, the information including a location for each of the plurality of neighbor BSs, and means for prioritizing the plurality of neighbor BSs to scan or handover based on distances between the location for each of the plurality of neighbor BSs and a location of the MS.

Certain embodiments of the present disclosure provide a mobile device. The mobile device generally includes collecting logic configured to obtain information about a plurality of neighbor BSs, the information including a location for each of the plurality of neighbor BSs, and prioritizing logic configured to prioritize the plurality of neighbor BSs to scan or handover based on distances between the location for each of the plurality of neighbor BSs and a location of the mobile device.

Certain embodiments of the present disclosure provide a method for advertising a plurality of neighbor BSs. The method generally includes obtaining information about the plurality of neighbor BSs, the information including a location for each of the plurality of neighbor BSs, and transmitting a message comprising the information.

Certain embodiments of the present disclosure provide a computer-program product for advertising a plurality of neighbor BSs, comprising a computer-readable medium having instructions stored thereon, the instructions being executable by one or more processors. The instructions generally include instructions for obtaining information about the plurality of neighbor BSs, the information including a location for each of the plurality of neighbor BSs, and instructions for transmitting a message comprising the information.

Certain embodiments of the present disclosure provide an apparatus for advertising a plurality of neighbor BSs. The apparatus generally includes means for obtaining information about the plurality of neighbor BSs, the information including a location for each of the plurality of neighbor BSs, and means for transmitting a message comprising the information.

Certain embodiments of the present disclosure provide a base station. The base station generally includes logic configured to obtain information about the plurality of neighbor BSs, the information including a location for each of the plurality of neighbor BSs, and a transmitter configured to transmit a message comprising the information.

### BRIEF DESCRIPTION OF THE DRAWINGS

So that the manner in which the above recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain embodiments of the present disclosure.

FIG. 2 illustrates various components that may be utilized in a wireless device, in accordance with certain embodiments of the present disclosure.

FIG. 3 illustrates an example transmitter and an example receiver that may be used within a wireless communication system that utilizes orthogonal frequency-division multiplexing and orthogonal frequency division multiple access (OFDM/OFDMA) technology, in accordance with certain embodiments of the present disclosure.

FIGS. 4A and 4B illustrate an example OFDM/OFDMA frame for Time Division Duplex (TDD) and the format of the Frame Control Header (FCH) contained therein, the FCH including downlink Frame Prefix (DLFP) information, in accordance with certain embodiments of the present disclosure.

FIG. 5 is a flow diagram of example operations for determining one or more neighbor base station (BS) candidates for a mobile station (MS) to scan or handover based on transmitting a location of the MS to the serving BS, in accordance with certain embodiments of the present disclosure.

FIG. 5A is a block diagram of means corresponding to the example operations of FIG. 5 for determining one or more neighbor BS candidates for an MS to scan or handover, in accordance with certain embodiments of the present disclosure.

FIGS. 6A and 6B illustrate transmitting a location of an MS to the serving BS and receiving a Neighbor Advertisement (MOB_NBR-ADV) message with a reduced set of neighbor BSs based on the location of the MS, in accordance with certain embodiments of the present disclosure.

FIG. 7 is a flow diagram of example operations for advertising a reduced set of one or more neighbor BS candidates with location information based on a received location of an MS, in accordance with certain embodiments of the present disclosure.

FIG. 7A is a block diagram of means corresponding to the example operations of FIG. 7 for advertising a reduced set of one or more neighbor BS candidates with location information, in accordance with certain embodiments of the present disclosure.

FIGS. 8A and 8B illustrate triggering a handover based on a comparison of distances between a serving BS and an MS and between a target BS and the MS, in accordance with certain embodiments of the present disclosure.

FIG. 9 is a flow diagram of example operations for advertising a plurality of neighbor base stations with location information, in accordance with certain embodiments of the present disclosure.

FIG. 9A is a block diagram of means corresponding to the example operations of FIG. 9 for advertising a plurality of neighbor base stations with location information, in accordance with certain embodiments of the present disclosure.

FIG. 10 illustrates a serving BS transmitting a MOB_NBR-ADV message with location information for the neighbor BSs to an MS, in accordance with certain embodiments of the present disclosure.

FIG. 11 is a table of BS information including GPS coordinates for each BS, in accordance with certain embodiments of the present disclosure.

FIG. 12 illustrates an MS traveling along a repeated route between two points and predicting a future location for an MS by knowing the BS information along the repeated route, in accordance with certain embodiments of the present disclosure.

FIG. 13 is a flow diagram of example operations for determining priority of neighbor base station candidates for an MS to scan or handover based on a location of the MS and obtained location information about a plurality of neighbor BSs, in accordance with certain embodiments of the present disclosure.

FIG. 13A is a block diagram of means corresponding to the example operations of FIG. 13 for determining priority of neighbor base station candidates for an MS to scan or handover, in accordance with certain embodiments of the present disclosure.

### DETAILED DESCRIPTION

Certain embodiments of the present disclosure provide methods and apparatus for using a location of a mobile station (MS) to assist network entry and initialization, scanning, and/or handover operations in a radio access technology (RAT) such as WiMAX. The location of the MS may be ascertained by determining the Global Positioning System (GPS) coordinates of the MS internally or by receiving the location from a GPS device external to the MS. Knowledge of the current or future location of the MS may reduce the amount of base station (BS) information transmitted to the MS; may reduce the power consumption and the amount of time spent during network entry, scanning, or handover; and may increase the bandwidth usage efficiency.

### Exemplary Wireless Communication System

The methods and apparatus of the present disclosure may be utilized in a broadband wireless communication system. The term “broadband wireless” refers to technology that provides wireless, voice, Internet, and/or data network access over a given area.

WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX offers the full mobility of cellular networks at broadband speeds.

Mobile WiMAX is based on OFDM (orthogonal frequency-division multiplexing) and OFDMA (orthogonal frequency division multiple access) technology. OFDM is a digital multi-carrier modulation technique that has recently found wide adoption in a variety of high-data-rate communication systems. With OFDM, a transmit bit stream is divided into multiple lower-rate substreams. Each substream is modulated with one of multiple orthogonal subcarriers and sent over one of a plurality of parallel subchannels. OFDMA is a multiple access technique in which users are assigned subcarriers in different time slots. OFDMA is a flexible multiple-access technique that can accommodate many users with widely varying applications, data rates, and quality of service requirements.

The rapid growth in wireless internets and communications has led to an increasing demand for high data rate in the field of wireless communications services. OFDM/OFDMA systems are today regarded as one of the most promising research areas and as a key technology for the next generation of wireless communications. This is due to the fact that OFDM/OFDMA modulation schemes can provide many advantages such as modulation efficiency, spectrum efficiency, flexibility, and strong multipath immunity over conventional single carrier modulation schemes.

IEEE 802.16x is an emerging standard organization to define an air interface for fixed and mobile broadband wireless access (BWA) systems. These standards define at least four different physical layers (PHYs) and one media access control (MAC) layer. The OFDM and OFDMA physical layer of the four physical layers are the most popular in the fixed and mobile BWA areas respectively.

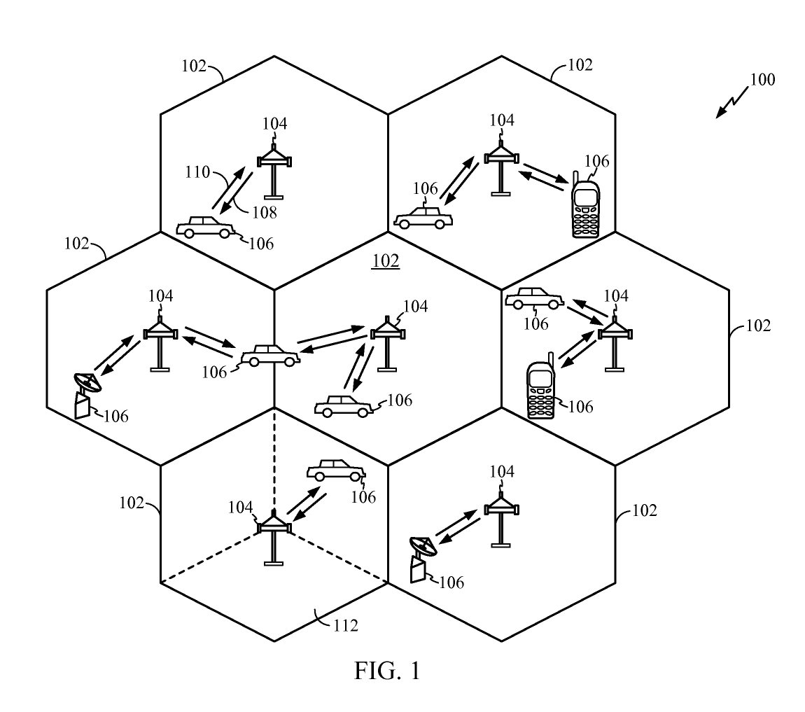

FIG. 1 illustrates an example of a wireless communication system 100. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers (PCs), etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

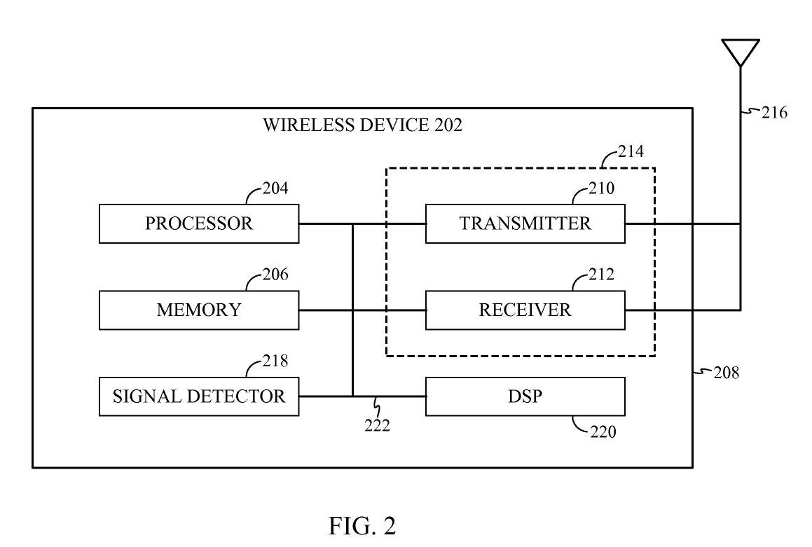

FIG. 2 illustrates various components that may be utilized in a wireless device 202. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy from pilot subcarriers or signal energy from the preamble symbol, power spectral density, and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

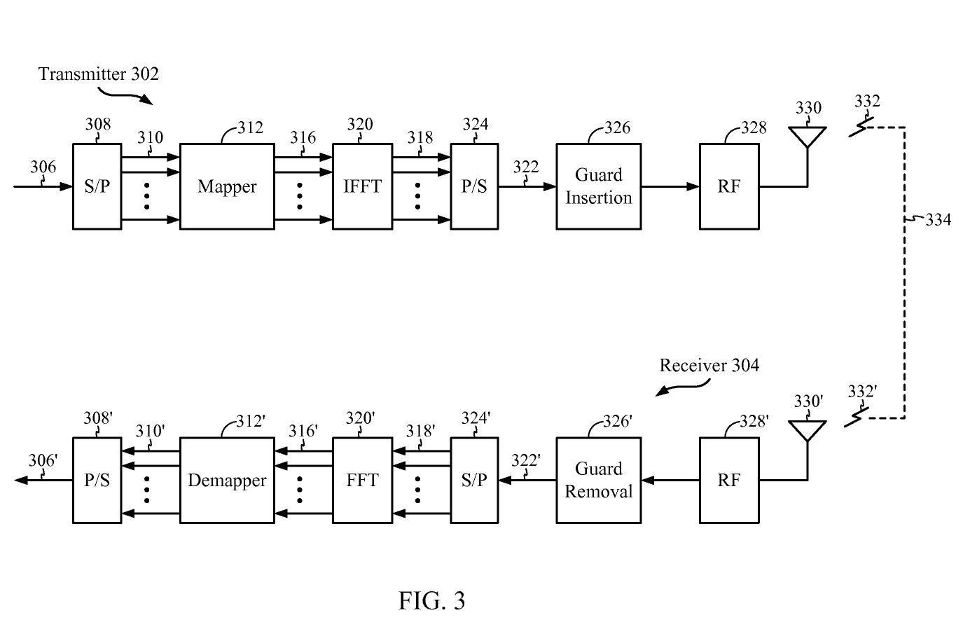

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Nₛ, is equal to N_{cp} (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless communication system 100 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312, thereby outputting N parallel data streams 310′. A P/S converter 308′ may combine the N parallel data streams 310′ into a single data stream 306′. Ideally, this data stream 306′ corresponds to the data 306 that was provided as input to the transmitter 302.

### Exemplary OFDM/OFDMA Frame

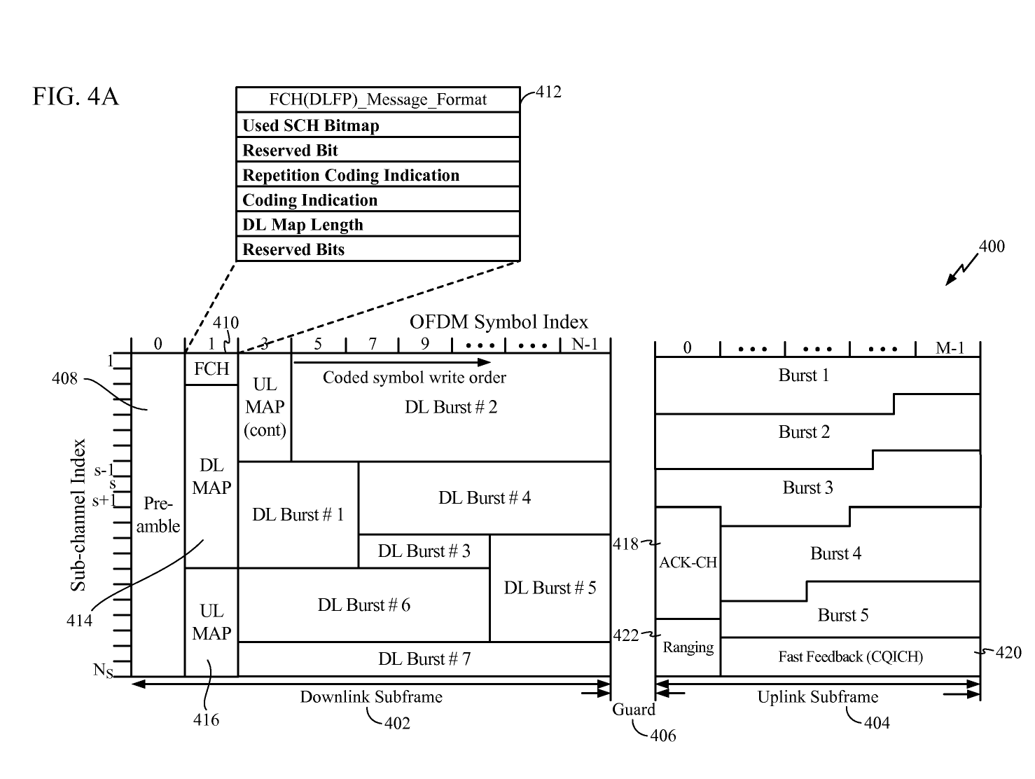

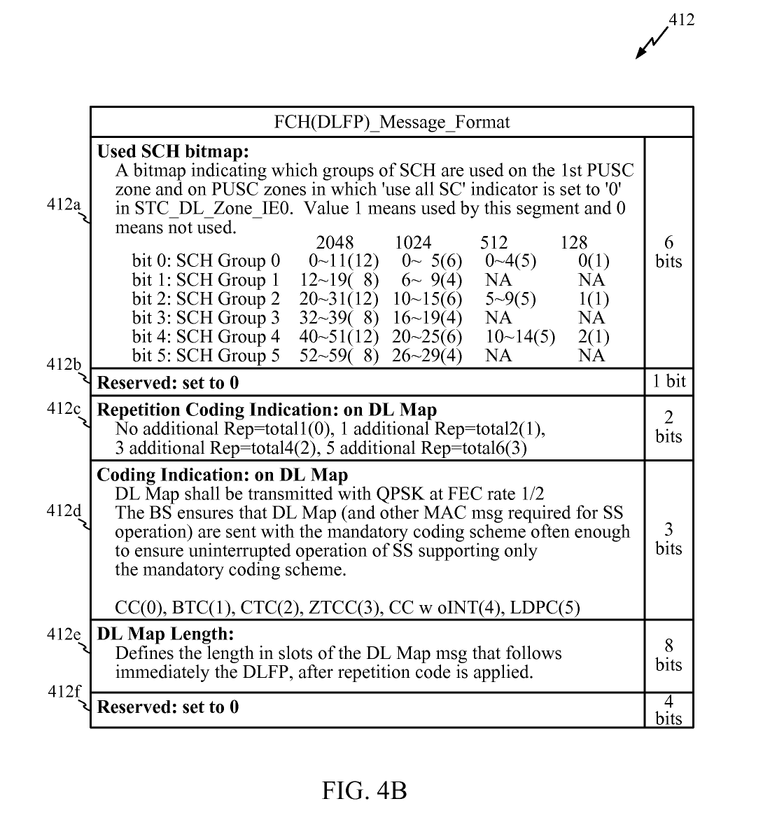

Referring now to FIG. 4A, an OFDM/OFDMA frame 400 for a Time Division Duplex (TDD) implementation is depicted as a typical, but not limiting, example. Other implementations of an OFDM/OFDMA frame, such as Full and Half-Duplex Frequency Division Duplex (FDD) may be used, in which case the frame is the same except that both downlink (DL) and uplink (UL) messages are transmitted simultaneously over different carriers. In the TDD implementation, each frame may be divided into a DL subframe 402 and a UL subframe 404, which may be separated by a small guard interval 406—or, more specifically, by Transmit/Receive and Receive/Transmit Transition Gaps (TTG and RTG, respectively)—in an effort to prevent DL and UL transmission collisions. The DL-to-UL-subframe ratio may be varied from 3:1 to 1:1 to support different traffic profiles.

Within the OFDM/OFDMA frame 400, various control information may be included. For example, the first OFDM/OFDMA symbol of the frame 400 may be a preamble 408, which may contain several pilot signals (pilots) used for synchronization. Fixed pilot sequences inside the preamble 408 may allow the receiver 304 to estimate frequency and phase errors and to synchronize to the transmitter 302. Moreover, fixed pilot sequences in the preamble 408 may be utilized to estimate and equalize wireless channels. The preamble 408 may contain BPSK-modulated carriers and is typically one OFDM symbol long. The carriers of the preamble 408 may be power boosted and are typically a few decibels (dB) (e.g., 9 dB) higher than the power level in the frequency domain of data portions in the WiMAX signal. The number of preamble carriers used may indicate which of the three segments of the zone are used. For example, carriers 0, 3, 6, . . . may indicate that segment 0 is to be used, carriers 1, 4, 7, . . . may indicate that segment 1 is to be used, and carriers 2, 5, 8, . . . may indicate that segment 2 is to be used.

A Frame Control Header (FCH) 410 may follow the preamble 408. The FCH 410 may provide frame configuration information, such as the usable subchannels, the modulation and coding scheme, and the MAP message length for the current OFDM/OFDMA frame. A data structure, such as the downlink Frame Prefix (DLFP) 412, outlining the frame configuration information may be mapped to the FCH 410.

As illustrated in FIG. 4B, the DLFP 412 for Mobile WiMAX may comprise six bits for the used subchannel (SCH) bitmap 412a, a reserved bit 412b set to 0, two bits for the repetition coding indication 412c, three bits for the coding indication 412d, eight bits for the MAP message length 412e, and four reserved bits 412f set to 0 for a total of 24 bits in the DLFP 412. Before being mapped to the FCH 410, the 24-bit DLFP may be duplicated to form a 48-bit block, which is the minimal forward error correction (FEC) block size.

Following the FCH 410, a DL-MAP 414 and a UL-MAP 416 may specify subchannel allocation and other control information for the DL and UL subframes 402, 404. In the case of OFDMA, multiple users may be allocated data regions within the frame, and these allocations may be specified in the DL and UL-MAP 414, 416. The MAP messages may include the burst profile for each user, which defines the modulation and coding scheme used in a particular link. Since MAP messages contain critical information that needs to reach all users, the DL and UL-MAP 414, 416 may often be sent over a very reliable link, such as BPSK or QPSK with rate ½ coding and repetition coding. The DL subframe 402 of the OFDM/OFDMA frame may include DL bursts of various bit lengths containing the downlink data being communicated. Thus, the DL-MAP 414 may describe the location of the bursts contained in the downlink zones and the number of downlink bursts, as well as their offsets and lengths in both the time (i.e., symbol) and the frequency (i.e., subchannel) directions.

Likewise, the UL subframe 404 may include UL bursts of various bit lengths composed of the uplink data being communicated. Therefore, the UL-MAP 416, transmitted as the first burst in the downlink subframe 402, may contain information about the location of the UL burst for different users. The UL subframe 404 may include additional control information as illustrated in FIG. 4A. The UL subframe 404 may include a UL ACK 418 allocated for the mobile station (MS) to feed back a DL hybrid automatic repeat request acknowledge (HARQ ACK) and/or a UL CQICH 420 allocated for the MS to feed back channel state information on the Channel Quality Indicator channel (CQICH). Furthermore, the UL subframe 404 may comprise a UL Ranging subchannel 422. The UL Ranging subchannel 422 may be allocated for the MS to perform closed-loop time, frequency, and power adjustment, as well as bandwidth requests. Altogether, the preamble 408, the FCH 410, the DL-MAP 414, and the UL-MAP 416 may carry information that enables the receiver 304 to correctly demodulate the received signal.

For OFDMA, different “modes” can be used for transmission in DL and UL. An area in the time domain where a certain mode is used is generally referred to as a zone. One type of zone is called DL-PUSC (downlink partial usage of subchannels) and may not use all the subchannels available to it (i.e., a DL-PUSC zone may only use particular groups of subchannels). There may be a total of six subchannel groups, which can be assigned to up to three segments. Thus, a segment can contain one to six subchannel groups (e.g., segment 0 contains three subchannel groups, segment 1 contains two, and segment 2 contains one subchannel group). Another type of zone is called DL-FUSC (downlink full usage of subchannels). Unlike DL-PUSC, DL-FUSC does not use any segments, but can distribute all bursts over the complete frequency range.

Exemplary Location-Assisted Scan or Handover using a Reduced Neighbor Set

Base stations supporting mobile functionality periodically transmit a Neighbor Advertisement (MOB_NBR-ADV) message to identify the WiMAX network and define the characteristics of neighbor base stations (BSs) to potential mobile stations (MSs) seeking network entry or handover. The MOB_NBR-ADV message typically contains the number of neighbor BSs and detailed information for each. An MS may use the information to determine a potential serving BS for network entry, candidate neighbor BSs for potential handovers, or a neighbor BS for an actual handover. With information for up to 255 neighbor BSs in IEEE 802.16e, the MOB_NBR-ADV message may be sizeable, and the MS may perform extensive processing in an effort to find the appropriate BS candidates among the neighbor BSs specified therein, thereby spending considerable time during network entry, scanning, or handover.

Accordingly, it may be desirable to reduce the size of the MOB_NBR-ADV message, or at least reducing the portion of the MOB_NBR-ADV message which the MS will process. Certain embodiments of the present disclosure utilize location of the MS and the neighbor BSs to accomplish these objectives.

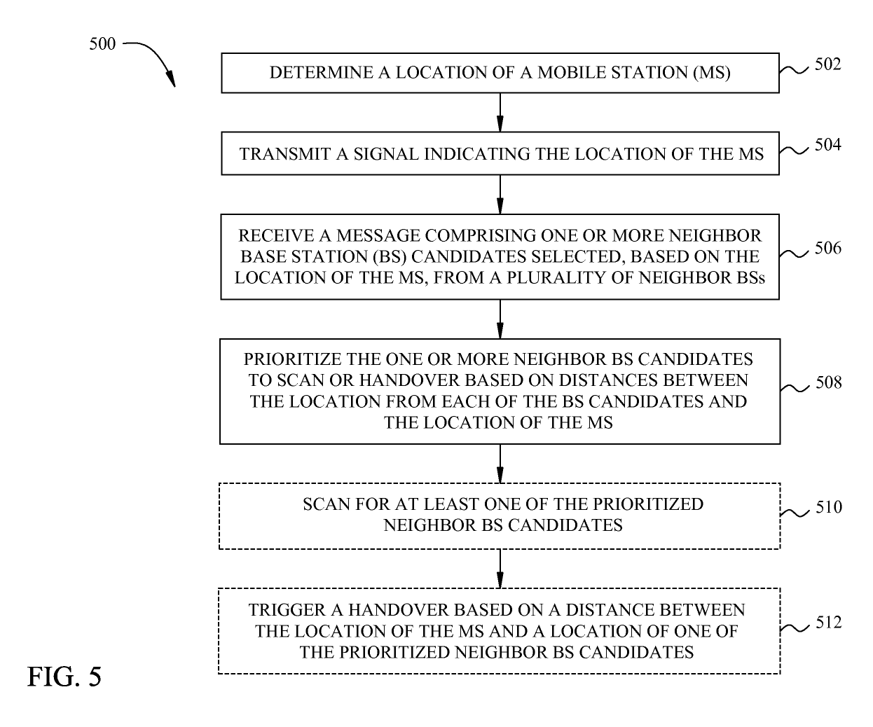

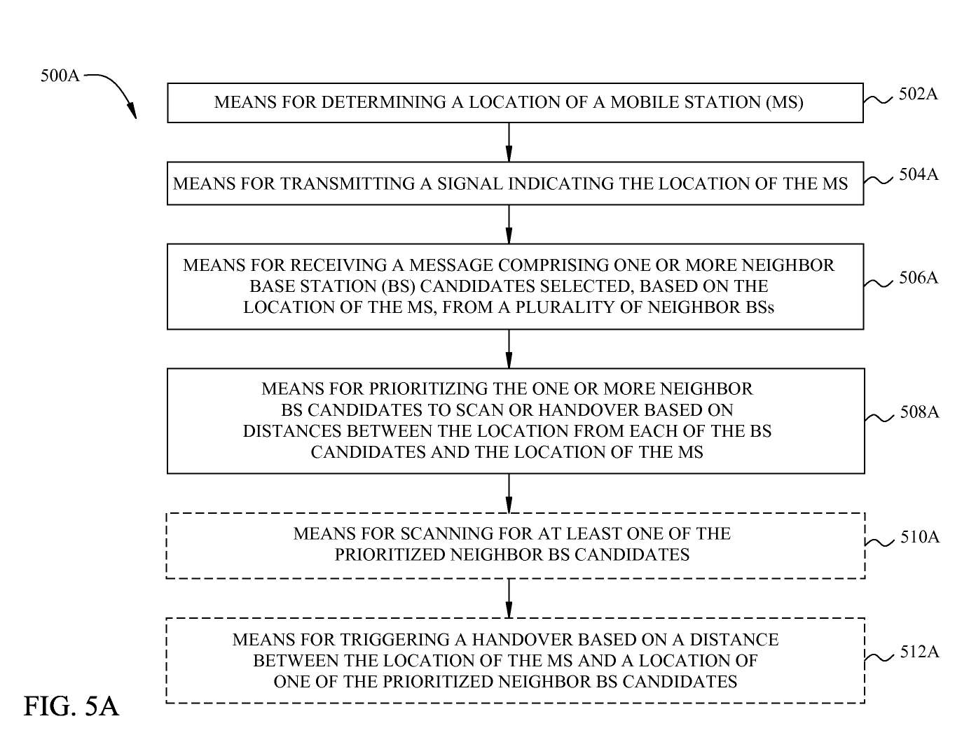

FIG. 5 is a flow diagram of example operations 500 for determining one or more neighbor BS candidates for an MS to scan or handover according to a reduced neighbor set, from the perspective of said MS. The operations 500 may begin, at 502, by determining a location of the MS. The location may be a current location, or if the speed and direction of the MS is known, the location may be a future location based on such a velocity vector and the current location for certain embodiments.

In an effort to describe the location of the MS with latitude and longitude, the location may be determined using the Global Positioning System (GPS) by the MS itself (for an MS with GPS capability). For other embodiments, the MS may communicate with an external device (e.g., a vehicle navigation system, a handheld GPS device, or a laptop computer running GPS software) to determine the MS's location. Communication between the MS and the external device may be performed via a cable or over the air (OTA). Because GPS devices have an uncertainty ranging from about 3 m to about 100 m for commercial-grade (as opposed to military-grade) depending on the measurement time and other factors, the location of the MS may include the GPS uncertainty and/or the measurement time for the position of the MS for certain embodiments.

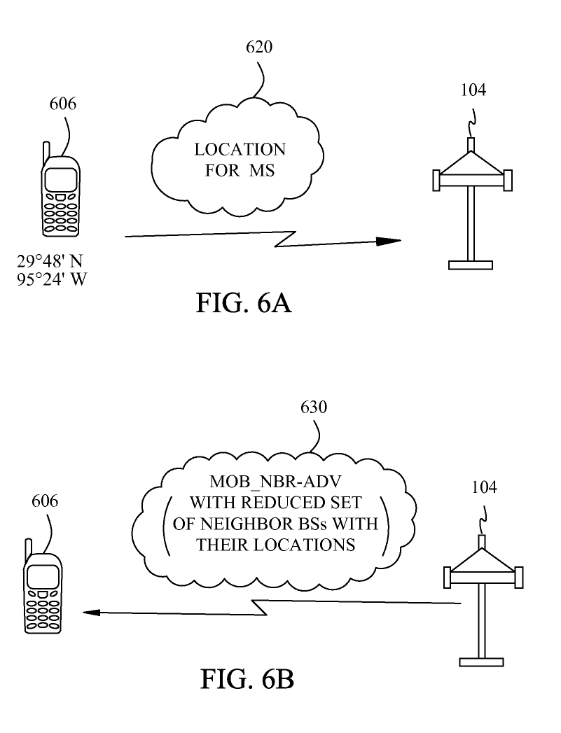

At 504 and as illustrated in FIG. 6A, the MS 606 may transmit a signal 620 indicating the location of the MS. The signal may include, for example, a message or a code representing the location of the MS. This signal 620 may be sent from the MS to a BS 104 during network entry and initialization. In FIG. 6A, for example, MS 606 currently has a location of 29°48′ N and 95°24′ W, which is transmitted to the BS 104. As described above, this MS location may also include GPS uncertainty, measurement time, traveling speed of the MS, and/or direction of travel.

At 506 and as portrayed in FIG. 6B, the MS 606 may receive a message 630 comprising information about one or more neighbor BS candidates, selected based on the MS's location, from a superset of known neighbor BSs. The message 630 may be a MOB_NBR-ADV message and, for some embodiments, may have location information, such as GPS coordinates, for each of the neighbor BS candidates. With this reduced neighbor set, the MS need not process information for all of the plurality of neighbor BSs, but may process information for the reduced number of neighbor BS candidates, thereby saving processing time.

At 508, the MS may prioritize the neighbor BS candidates based on distances between the current or future location of the MS and the locations for each of the BS candidates. For example, neighbor BS candidates closer to the location of the MS may have higher priority for scanning or handover than candidates further away from the location of the MS. The MS may store a prioritized list of neighbor BS candidates in memory for subsequent accessing or updating.

Optionally at 510, the MS may scan for at least one of the prioritized neighbor BS candidates for network entry or potential handover. For example, the MS may try to register with the BS candidate having the highest priority, which may most likely be the neighbor BS closest to the current or future location of the MS. In this manner, time spent during network entry may be reduced. As another example, the MS may scan for one or more of the closest neighbor BSs according to the prioritized list in an effort to monitor the suitability of neighbor BSs as targets for handover.

Also optionally at 512, the MS may trigger a handover based on the location of the MS and a location of one of the prioritized neighbor BS candidates. An example method for triggering a handover based on location information is described in greater detail below.

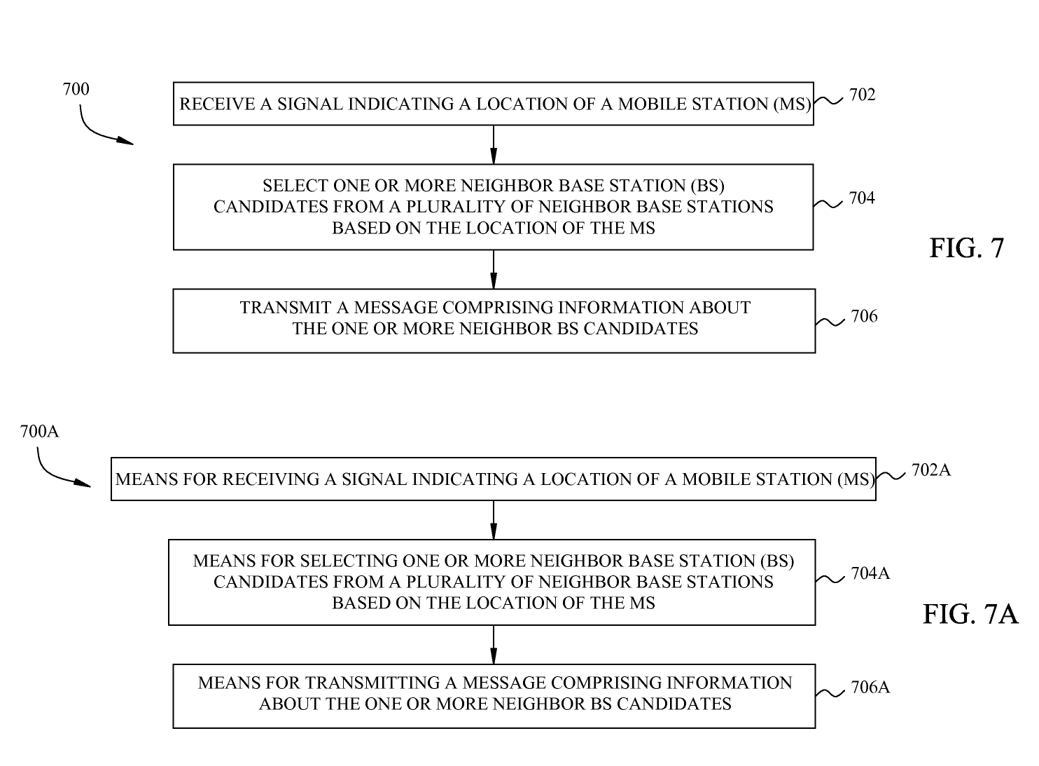

FIG. 7 is a flow diagram of example operations 700 for advertising a reduced set of one or more neighbor BS candidates with location information based on a received location of an MS, from the perspective of a BS. The operations 700 may begin, at 702, by receiving a signal 620 indicating the location of the MS 606, as illustrated in FIG. 6A.

At 704, the BS 104 may select one or more neighbor BS candidates from a plurality of neighbor BSs based on the location of the MS. For example, the BS may know about the plurality of neighbor BSs from the WiMAX network backbone and may have information about each of the plurality of neighbor BSs, including their locations. The BS may select neighbor BS candidates that have a location close to the location received from the MS. For some embodiments, the BS may calculate the distances between the location of each of the plurality of neighbor BSs and the MS's location and choose any neighbor BSs having a distance to the MS's location less than a threshold in an effort to select the neighbor BS candidates. In this manner, the number of neighbor BSs may be reduced such that the neighbor BS candidates represent a subset of the known neighbor BSs.

At 706 as illustrated in FIG. 6B, the BS 104 may transmit a message 630 comprising information about the one or more neighbor BS candidates, selected based on the MS's location, to the MS 606. The message 630 may be a MOB_NBR-ADV message and, for some embodiments, may have location information, such as GPS coordinates, for each of the neighbor BS candidates.

### Exemplary Technique for Triggering Handover Based on Location Information

As referred to above with respect to 512 of FIG. 5, the MS may trigger a handover based on the location of the MS and a location of one of the prioritized neighbor BS candidates. For example, the MS may decide to attempt a handover once the distance (D_{MS-sBS}) between the MS's location and the serving BS's location is greater than the distance (D_{MS-tBS}) between the MS's location and a target BS's (i.e., one of the prioritized neighbor BS candidates) location by a certain threshold (D_{MS-sBS}-D_{MS-tBS}>THR). As another example, the MS may decide to attempt a handover to a prioritized candidate target BS if the direction of the MS movement is toward the candidate target BS. For some embodiments, the MS may decide to attempt a handover to a candidate target BS if either or both the direction of the MS movement and the distance to the MS favor the candidate target BS over the serving BS.

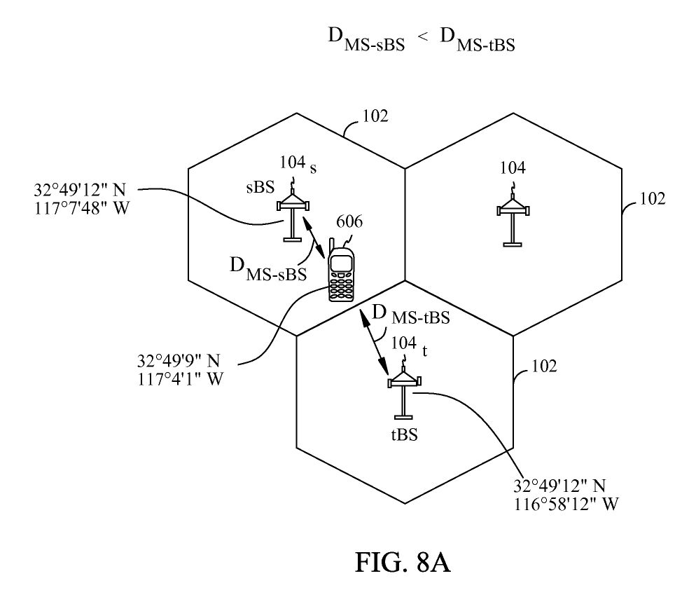

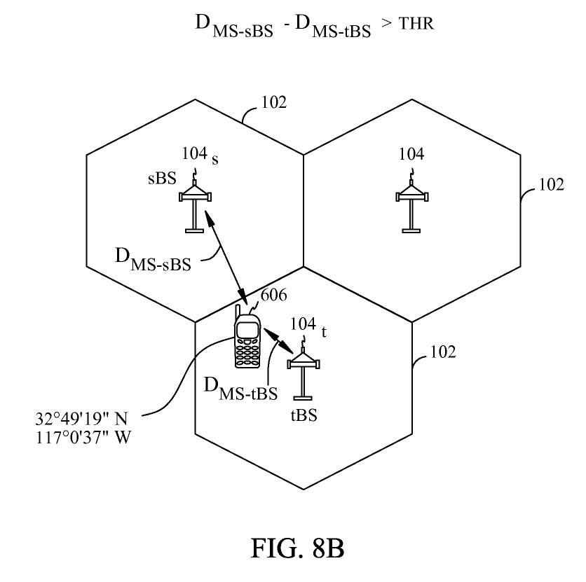

FIG. 8A illustrates a mobile station 606 exchanging data with a serving base station (sBS) 104ₛ. The location of the serving BS 104ₛ is known to be 32°49′12″ N and 117°7′48″ W. In this case, the current location of the MS 606 may be determined (e.g., by the MS 606 or a device external to the MS) as 32°49′9″ N and 117°4′1″ W. By knowing these two sets of coordinates, the MS 606 may calculate the distance (D_{MS-sBS}) between the MS and the serving BS.

For some embodiments, the coordinates of the base stations may be known precisely, while for other embodiments, the coordinates of the base stations may be determined by a commercial-grade GPS device, which has an uncertainty ranging from about 3 m to 100 m depending on the device used. All the coordinates for the mobile stations may have uncertainty ranging from 3 m to 100 m. The example coordinates provided in the present disclosure are for illustrative purposes and may not accurately reflect practical distances between neighboring base stations or between an MS and a serving BS providing network coverage to said MS.

Furthermore, the MS 606 may obtain information about the location of a potential target base station (tBS) 104ₜ. For some embodiments, this tBS location information may be provided to the MS 606 in the reduced neighbor set received from the sBS 104ₛ as described above. The location of the target BS 104ₜ is disclosed as 32°49′12″ N and 116°58′12″ W, and the MS 606 may calculate the distance (D_{MS-tBS}) between the MS and the target BS. In FIG. 8A, D_{MS-sBS} is less than D_{MS-tBS}, and therefore, the MS does not trigger a handover from the serving BS 104ₛ to the target BS 104ₜ.

In FIG. 8B, the MS 606 has moved to a new location determined by the MS 606 or a device external to the MS as 32°49′19″ N and 117°0′37″. The MS 606 may calculate D_{MS-sBS} and D_{MS-tBS} with the new location of the MS and determine that D_{MS-sBS}-D_{MS-tBS} is greater than a threshold (THR), thereby triggering a handover to the target BS 104ₜ. The threshold may be a predetermined value stored on the MS 606 and is intended to provide some hysteresis to handover triggering decisions such that mobile stations traveling approximately equidistant to two BSs are not forced to repeatedly and needlessly handover between the two BSs, depending on which BS an MS is currently closer to at any given time. Moreover, by taking location uncertainty into account to calculate maximum and minimum estimated distances, an additional degree of number padding may be provided to aid hysteresis and prevent needless handovers.

Triggering a handover using location information in this manner may be combined with other handover triggering methods in an effort to make a more informed handover decision. Other handover triggering methods may include comparing the carrier-to-interference-plus-noise ratio (CINR), the received signal strength indicator (RSSI), or the round trip delay (RTD) between the serving BS and a target BS. These other handover trigger methods may be employed when the GPS measurement is not available or not accurate enough to trigger a handover using location information. The BS may direct the MS to use one or a combination of handover triggering methods, including the location-assisted handover triggering method described above.

### Exemplary Neighbor List Prioritization Based on Location Information

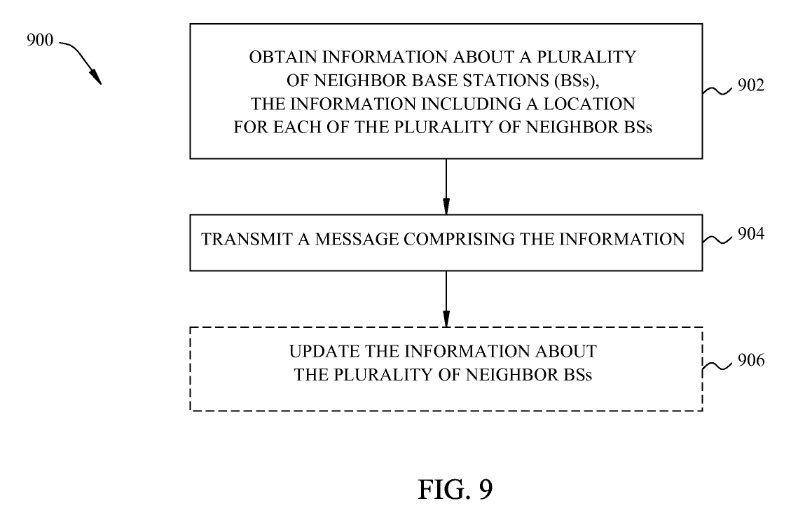

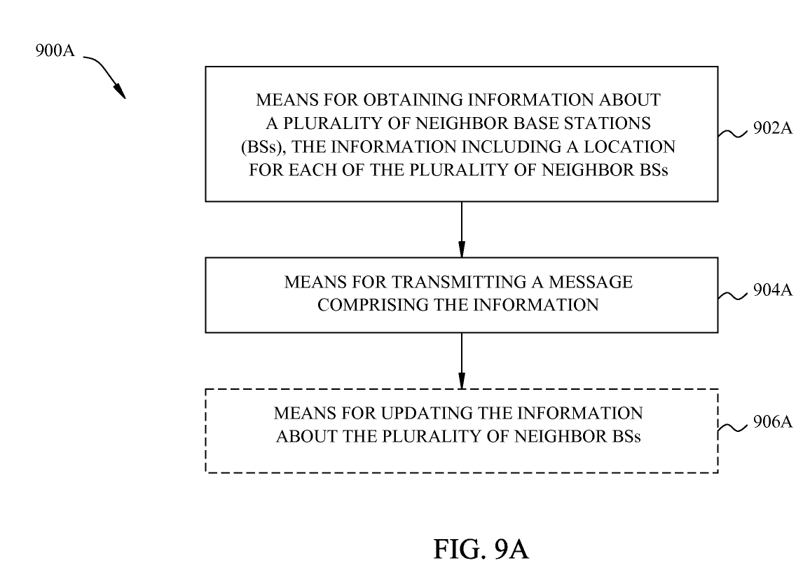

There are other methods for providing location information for neighbor BSs to an MS and using such location information in conjunction with a location of the MS for network entry, scanning, and handover procedures. For example, FIG. 9 is a flow diagram of example operations 900 for advertising a plurality of neighbor base stations with location information, in accordance with certain embodiments of the present disclosure. The operations 900 may begin, at 902, by obtaining information about a plurality of neighbor BSs, wherein the information may include a location for each of the plurality of neighbor BSs. Such information may be supplied by the network service provider (NSP)/network access provider (NAP) to a BS via the network backbone connecting several BSs together.

At 904, the BS may transmit a message comprising this information, including the location for each of the plurality of neighbor BSs. The message may be a Neighbor Advertisement (MOB_NBR-ADV) message, and the location information may be GPS coordinates for each of the plurality of neighbor BS. The message may be broadcast periodically.

Optionally at 906, the information about the plurality of neighbor BSs may be updated, such as whenever a new base station is added to the WiMAX network or an existing BS is removed. The NSP/NAP may notify the BS of the updated information via the backbone. The BS may transmit a new message comprising the updated information during subsequent periodic broadcasts.

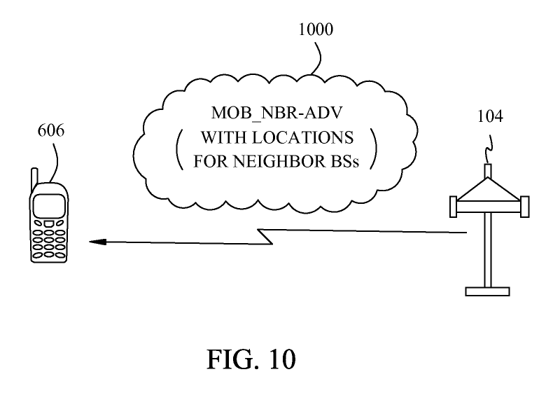

FIG. 10 illustrates a BS 104 transmitting a MOB_NBR-ADV message 1000 with location information for the neighbor BSs to an MS 606, in accordance with certain embodiments of the present disclosure. In contrast with a BS that receives a signal indicating a location of the MS, the BS 104 in FIG. 10 may not know the location of the MS 606. Therefore, the BS 104 may not be able to select a reduced set of neighbor BS candidates based on the location of the MS as described above; rather, the BS 104 may transmit location information for all of the known plurality of neighbor BSs.

For some embodiments, location information, such as GPS coordinates, for neighbor base stations may be stored in a database on the MS. This database may be provided by the network service provider or MS manufacturer, may be transmitted to the MS by the network during device activation or subsequent operation, or may be learned by the MS during normal operations. Furthermore, this database may be updated during network entry and initialization or subsequent operations.

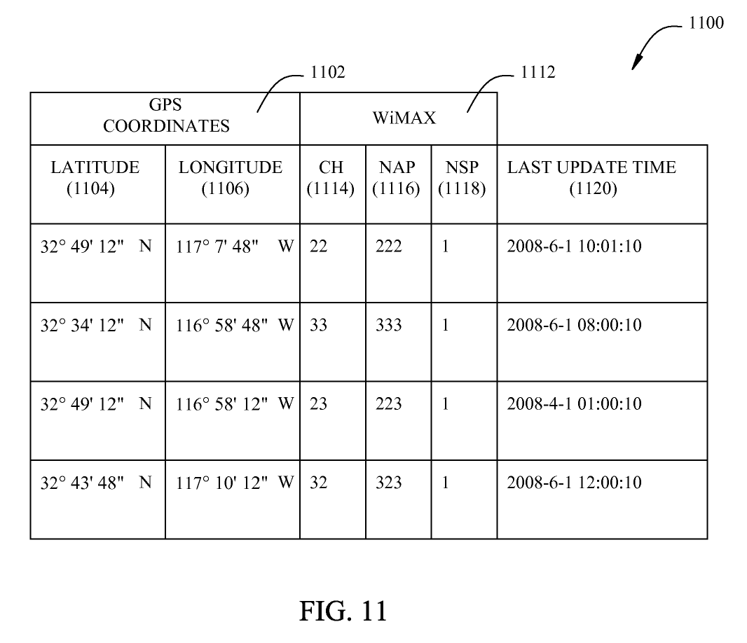

FIG. 11 illustrates an example table 1100 of BS information including location information, where each row of the table 1100 may be stored as a record in the database. The columns of the table 1100 may be grouped into a GPS coordinates section 1102 and a WiMAX section 1112. The GPS coordinates section 1102 may include a latitude column 1104 and a longitude column 1106 providing the latitude and longitude, respectively, of the base station in the record. The WiMAX section 1112 may contain a channel number column 1114, a Network Access Provider (NAP) column 1116, a Network Service Provider (NSP) column 916, and/or a Base Station Identification Number (BSID) (not shown).

Each record in the table 1100 may also include a last update time column 1120 for a time stamp as shown. Because the network topology and coverage of the WiMAX network may change with time, the time stamp may indicate how recently the record was updated. The time stamp may be taken into consideration when prioritizing a list of neighbor BSs from the database, as described in greater detail below. Furthermore, the time stamp may be used to select and delete older entries from the database in an effort to conserve memory of the MS.

By knowing its current or a future location, the MS 606 may access the database with records having information similar to rows in table 1100. The MS 606 may select one or more records having GPS coordinates close to its current location. Logic on the MS may perform this selection using a distance-calculating algorithm, for example, and choosing the closest n base stations, where n is a predetermined integer, or picking all of the base stations closer than a certain threshold distance. By having the BS information readily available in the database, the MS may quickly acquire a BS for network service, whether for initial registration or session restoration, or potential handover without having to wait for a MOB_NBR-ADV message.

When the entries in the database are learned, the database may adapt to changes in the network topology, such as the addition of new BSs. Furthermore, only entries related to the coverage areas where the user operates the MS may be stored, thereby using less memory than a database with BS information records for an entire region. These learned entries may be refined over time as the user continues to use the MS in these areas.

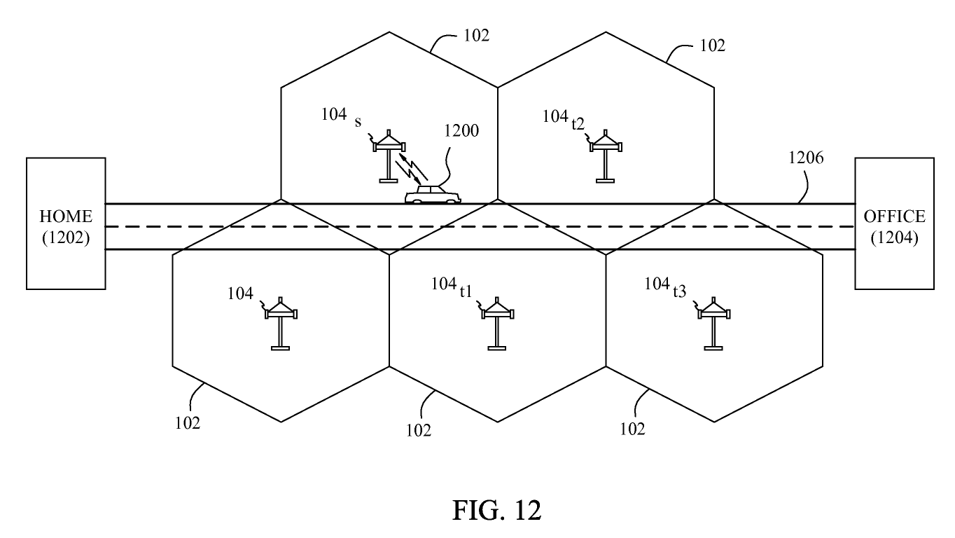

FIG. 12 illustrates a mobile station 1200 traveling from a first location, such as a home 1202, to a second location, such as an office 1204. The route taken between the two locations 1202, 1204, may include a highway 1206, and several base stations 104 may provide network service to the MS 1200 as it travels. Because traveling along the highway 1206 is a frequent route for the MS 1200, the MS may learn the BS information (e.g., GPS coordinates) for each of the BSs 104 that provide network service to the MS 1200 along its route and store this information in a database By knowing its current location, the MS 1200 may be able to access this database and trigger handover to another BS (e.g., from serving BS 104ₛ to first target BS 104ₜ₁) once D_{MS-sBS}-D_{MS-tBS}>THR as described above.

Furthermore, because much of the infrastructure for traveling (e.g., highways, subways, and railways) runs along predictable routes (e.g., routes that are relatively straight for substantial distances), a mobile station may be able to predict a future location based on its current location, its current speed, and its current travel direction. By knowing a future location and location information for neighbor BSs, an MS may determine which neighbor BSs to scan and when to perform a handover. For example, the MS 1200 may know where to handover to target BS 1 (104t₁), target BS 2 (104t₂), and target BS 3 (104t₃) as the MS travels along the highway 1206. These handovers may be performed with reduced scanning and without waiting for or processing a MOB_NBR-ADV message, thereby saving processing time that may be used instead for higher bandwidth usage efficiency. Reduced scanning may comprise scanning for potential handover candidates, including as-yet-unknown BSs, with a reduced set of neighbor BS candidates for potential handovers.

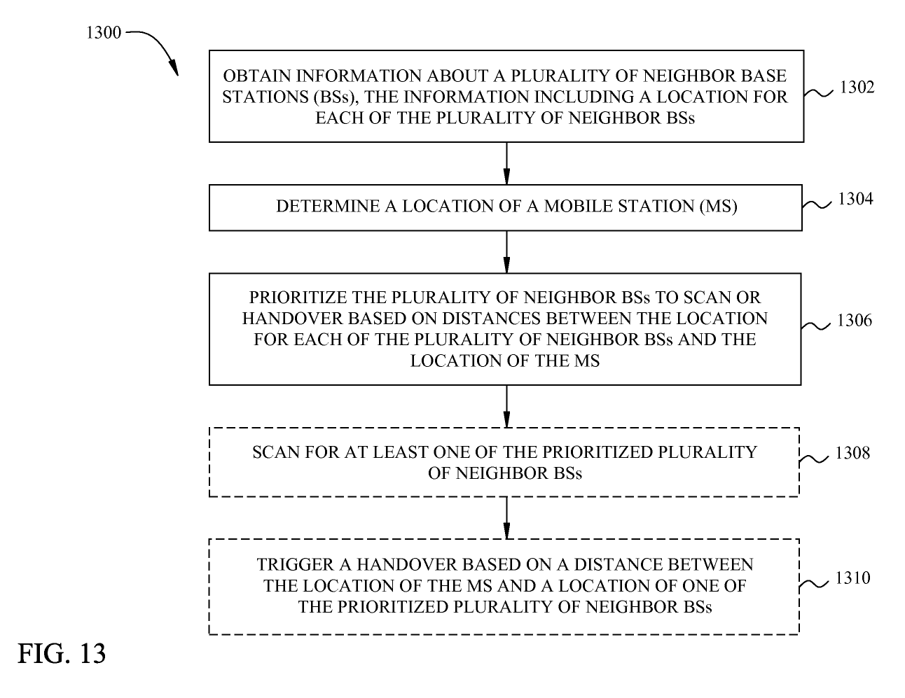

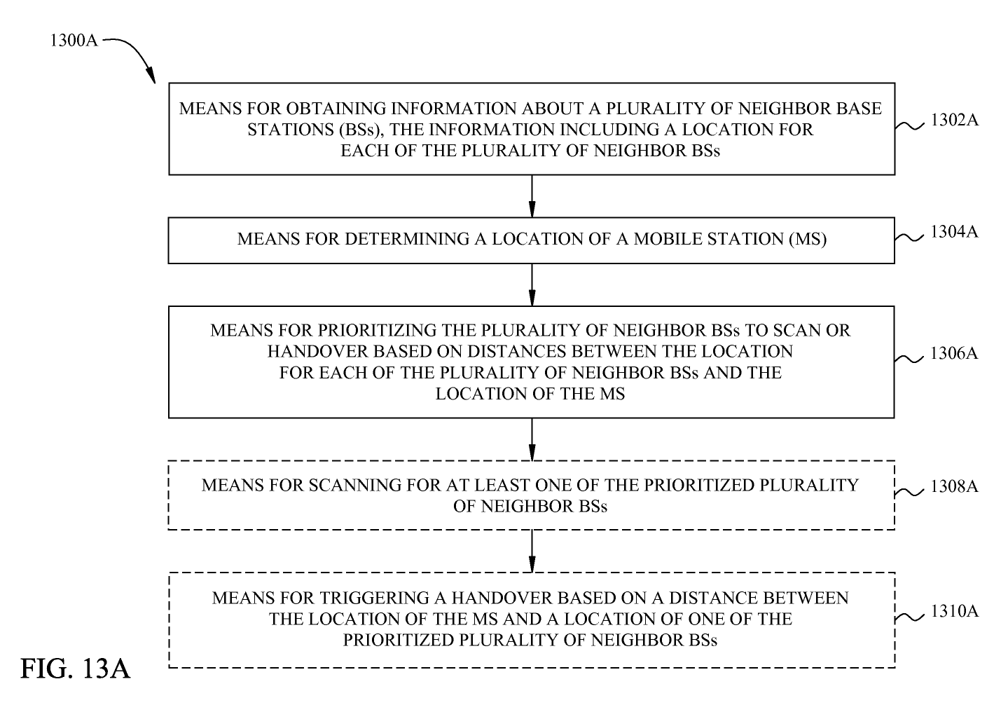

FIG. 13 is a flow diagram of example operations 1300 for determining priority of neighbor base station candidates for an MS to scan or handover based on a location of the MS and obtained location information about a plurality of neighbor BSs from the perspective of the MS. The operations 1300 may begin, at 1302, by obtaining information about a plurality of neighbor BSs including a location for each. Such location information may be obtained from a MOB_NBR-ADV message 1000 or a database provided by the network service provider or MS manufacturer, transmitted to the MS by the network during device activation or subsequent operation, or learned by the MS during normal operation, as described above.

At 1304, a location of the MS may be determined (by means internal or external to the MS). The location may be a current location, or if the speed and direction of the MS are known, the location may be a future location based on such a velocity vector and the current location for certain embodiments as described above.

At 1306, the MS may prioritize the neighbor BS candidates based on distances between the current or future location of the MS and the locations for each of the BS candidates, as described above with respect to 508 of FIG. 5. For example, neighbor BS candidates closer to the location of the MS may have higher priority for scanning or handover than candidates further away from the location of the MS. For some embodiments, the MS may prioritize the neighbor BS candidates based on the direction of the MS movement and the distance to the neighbor BS candidates. The MS may store a prioritized list of neighbor BS candidates in memory for subsequent accessing or updating.

Optionally at 1308, the MS may scan for at least one of the prioritized neighbor BS candidates for network entry or potential handover, as described above with respect to 510 of FIG. 5. For example, the MS may try to register with the BS candidate having the highest priority, which may most likely be the neighbor BS closest to the current or future location of the MS. In this manner, time spent during network entry may be reduced. As another example, the MS may scan for one or more of the closest neighbor BSs according to the prioritized list in an effort to monitor the suitability of neighbor BSs as targets for handover.

Also optionally at 1310, the MS may trigger a handover based on the location of the MS and a location of one of the prioritized neighbor BS candidates, as described above with respect to 512 of FIG. 5. For example, the MS may decide to attempt a handover once the distance (D_{MS-sBS}) between the MS's location and the serving BS's location is greater than the distance (D_{MS-tBS}) between the MS's location and a target BS's (i.e., one of the prioritized neighbor BS candidates) location by a certain threshold (D_{MS-sBS}-D_{MS-tBS}>THR). As another example, the MS may decide to attempt a handover to a prioritized candidate target BS if the direction of the MS movement is toward the candidate target BS. For some embodiments, the MS may decide to attempt a handover to a candidate target BS if either or both the direction of the MS movement and the distance to the MS favor the candidate target BS.

The various operations of methods described above may be performed by various hardware and/or software component(s) and/or module(s) corresponding to means-plus-function blocks illustrated in the Figures. Generally, where there are methods illustrated in Figures having corresponding counterpart means-plus-function Figures, the operation blocks correspond to means-plus-function blocks with similar numbering. For example, blocks 502-512 illustrated in FIG. 5 correspond to means-plus-function blocks 502A-512A illustrated in FIG. 5A, and blocks 702-706 illustrated in FIG. 7 correspond to means-plus-function blocks 702A-706A illustrated in FIG. 7A.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by one or more processors, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for determining one or more neighbor base station (BS) candidates for a mobile station (MS) to scan or handover, comprising:
transmitting a signal indicating a location of the MS; and
receiving a message comprising the one or more neighbor BS candidates selected, based on the location of the MS, from a plurality of neighbor base stations.

2. The method of claim 1, wherein the message comprises a Neighbor Advertisement (MOB_NBR-ADV) message.

3. The method of claim 1, further comprising determining the location of the MS using the Global Positioning System (GPS).

4. The method of claim 3, wherein determining the location of the MS comprises communicating with a GPS device external to the MS.

5. The method of claim 1, wherein the location is a future location of the MS based on a velocity vector and a current location of the MS.

6. The method of claim 1, wherein the message comprises a location for each of the one or more neighbor BS candidates selected.

7. The method of claim 6, further comprising prioritizing the one or more neighbor BS candidates to scan or handover based on distances between the location for each of the BS candidates and the location of the MS.

8. The method of claim 7, further comprising scanning for at least one of the prioritized neighbor BS candidates.

9. The method of claim 7, further comprising triggering a handover based on a distance between the location of the MS and a location of one of the prioritized neighbor BS candidates.

10. The method of claim 6, further comprising prioritizing the one or more neighbor BS candidates to scan or handover based on a movement direction of the MS or based on the movement direction of the MS and distances between the location for each of the BS candidates and the location of the MS.

11. A computer-program product for determining one or more neighbor base station (BS) candidates for a mobile station (MS) to scan or handover, comprising a computer-readable medium having instructions stored thereon, the instructions being executable by one or more processors and the instructions comprising:
instructions for transmitting a signal indicating a location of the MS; and
instructions for receiving a message comprising the one or more neighbor BS candidates selected, based on the location of the MS, from a plurality of neighbor base stations.

12. The computer-program product of claim 11, wherein the message comprises a Neighbor Advertisement (MOB_NBR-ADV) message.

13. The computer-program product of claim 11, further comprising instructions for determining the location of the MS using the Global Positioning System (GPS).

14. The computer-program product of claim 13, wherein determining the location of the MS comprises communicating with a GPS device external to the MS.

15. The computer-program product of claim 11, wherein the location is a future location of the MS based on a velocity vector and a current location of the MS.

16. The computer-program product of claim 11, wherein the message comprises a location for each of the one or more neighbor BS candidates selected.

17. The computer-program product of claim 16, further comprising instructions for prioritizing the one or more neighbor BS candidates to scan or handover based on distances between the location for each of the BS candidates and the location of the MS.

18. The computer-program product of claim 17, further comprising instructions for scanning for at least one of the prioritized neighbor BS candidates.

19. The computer-program product of claim 17, further comprising instructions for triggering a handover based on a distance between the location of the MS and a location of one of the prioritized neighbor BS candidates.

20. The computer-program product of claim 16, further comprising instructions for prioritizing the one or more neighbor BS candidates to scan or handover based on a movement direction of the MS or based on the movement direction of the MS and distances between the location for each of the BS candidates and the location of the MS.

21. An apparatus for determining one or more neighbor base station (BS) candidates for a mobile station (MS) to scan or handover, comprising:
means for transmitting a signal indicating a location of the MS; and
means for receiving a message comprising the one or more neighbor BS candidates selected, based on the location of the MS, from a plurality of neighbor base stations.

22. The apparatus of claim 21, wherein the message comprises a Neighbor Advertisement (MOB_NBR-ADV) message.

23. The apparatus of claim 21, further comprising means for determining the location of the MS using the Global Positioning System (GPS).

24. The apparatus of claim 23, wherein the means for determining the location of the MS comprise a GPS device external to the MS.

25. The apparatus of claim 21, wherein the location is a future location of the MS based on a velocity vector and a current location of the MS.

26. The apparatus of claim 21, wherein the message comprises a location for each of the one or more neighbor BS candidates selected.

27. The apparatus of claim 26, further comprising means for prioritizing the one or more neighbor BS candidates to scan or handover based on distances between the location for each of the BS candidates and the location of the MS.

28. The apparatus of claim 27, further comprising means for scanning for at least one of the prioritized neighbor BS candidates.

29. The apparatus of claim 27, further comprising means for triggering a handover based on a distance between the location of the MS and a location of one of the prioritized neighbor BS candidates.

30. The apparatus of claim 26, further comprising means for prioritizing the one or more neighbor BS candidates to scan or handover based on a movement direction of the MS or based on the movement direction of the MS and distances between the location for each of the BS candidates and the location of the MS.

31. A mobile device, comprising:
a transmitter configured to transmit a signal indicating a location of the mobile device; and
a receiver configured to receive a message comprising one or more neighbor base station (BS) candidates selected, based on the location of the mobile device, from a plurality of neighbor base stations.

32. The mobile device of claim 31, wherein the message comprises a Neighbor Advertisement (MOB_NBR-ADV) message.

33. The mobile device of claim 31, further comprising logic configured to determine the location of the mobile device using the Global Positioning System (GPS).

34. The mobile device of claim 33, wherein the logic is configured to determine the location of the mobile device by communicating with a GPS device external to the mobile device.

35. The mobile device of claim 31, wherein the location is a future location of the mobile device based on a velocity vector and a current location of the mobile device.

36. The mobile device of claim 31, wherein the message comprises a location for each of the one or more neighbor BS candidates selected.

37. The mobile device of claim 36, further comprising logic configured to prioritize the one or more neighbor BS candidates to scan or handover based on distances between the location for each of the BS candidates and the location of the mobile device.

38. The mobile device of claim 37, wherein the logic is configured to scan for at least one of the prioritized neighbor BS candidates.

39. The mobile device of claim 37, wherein the logic is configured to trigger a handover based on a distance between the location of the mobile device and a location of one of the prioritized neighbor BS candidates.

40. The mobile device of claim 37, further comprising logic configured to prioritize the one or more neighbor BS candidates to scan or handover based on a movement direction of the mobile device or based on the movement direction of the mobile device and distances between the location for each of the BS candidates and the location of the mobile device.

41. A method for advertising one or more neighbor base station (BS) candidates, comprising:
receiving a signal indicating a location of a mobile station (MS);
based on the location of the MS, selecting the one or more neighbor BS candidates from a plurality of neighbor base stations; and
transmitting a message comprising information about the one or more neighbor BS candidates.

42. The method of claim 41, wherein the message comprises a Neighbor Advertisement (MOB_NBR-ADV) message.

43. The method of claim 41, wherein the location of the MS comprises Global Positioning System (GPS) coordinates.

44. The method of claim 41, wherein selecting the one or more neighbor BS candidates comprises:
calculating distances between locations for the plurality of neighbor base stations and the location of the MS; and
grouping into the one or more neighbor BS candidates any of the plurality of base stations with a distance to the location of the MS less than a threshold.

45. The method of claim 44, wherein the locations for the plurality of neighbor base stations comprise Global Positioning System (GPS) coordinates.

46. The method of claim 41, wherein the location of the MS is a future location of the MS based on a velocity vector and a current location of the MS.

47. The method of claim 41, wherein the information comprises a location for each of the one or more neighbor BS candidates.

48. A computer-program product for advertising one or more neighbor base station (BS) candidates, comprising a computer-readable medium having instructions stored thereon, the instructions being executable by one or more processors and the instructions comprising:
instructions for receiving a signal indicating a location of a mobile station (MS);
instructions for selecting the one or more neighbor BS candidates from a plurality of neighbor base stations based on the location of the MS; and
instructions for transmitting a message comprising information about the one or more neighbor BS candidates.

49. The computer-program product of claim 48, wherein the message comprises a Neighbor Advertisement (MOB_NBR-ADV) message.

50. The computer-program product of claim 48, wherein the location of the MS comprises Global Positioning System (GPS) coordinates.

51. The computer-program product of claim 48, wherein the instructions for selecting the one or more neighbor BS candidates comprise:
instructions for calculating distances between locations for the plurality of neighbor base stations and the location of the MS; and
instructions for grouping into the one or more neighbor BS candidates any of the plurality of base stations with a distance to the location of the MS less than a threshold.

52. The computer-program product of claim 51, wherein the locations for the plurality of neighbor base stations comprise Global Positioning System (GPS) coordinates.

53. The computer-program product of claim 48, wherein the location of the MS is a future location of the MS based on a velocity vector and a current location of the MS.

54. The computer-program product of claim 48, wherein the information comprises a location for each of the one or more neighbor BS candidates.

55. An apparatus for advertising one or more neighbor base station (BS) candidates, comprising:
means for receiving a signal indicating a location of a mobile station (MS);
means for selecting the one or more neighbor BS candidates from a plurality of neighbor base stations based on the location of the MS; and
means for transmitting a message comprising information about the one or more neighbor BS candidates.

56. The apparatus of claim 55, wherein the message comprises a Neighbor Advertisement (MOB_NBR-ADV) message.

57. The apparatus of claim 55, wherein the location of the MS comprises Global Positioning System (GPS) coordinates.

58. The apparatus of claim 55, wherein the means for selecting the one or more neighbor BS candidates are configured to calculate distances between locations for the plurality of neighbor base stations and the location of the MS and to group into the one or more neighbor BS candidates any of the plurality of base stations with a distance to the location of the MS less than a threshold.

59. The apparatus of claim 58, wherein the locations for the plurality of neighbor base stations comprise Global Positioning System (GPS) coordinates.

60. The apparatus of claim 55, wherein the location of the MS is a future location of the MS based on a velocity vector and a current location of the MS.

61. The apparatus of claim 55, wherein the information comprises a location for each of the one or more neighbor BS candidates.

62. A base station, comprising:
a receiver configured to receive a signal indicating a location of a mobile station (MS);
logic configured to select one or more neighbor base station (BS) candidates from a plurality of neighbor base stations based on the location of the MS; and
a transmitter configured to transmit a message comprising information about the one or more neighbor BS candidates.

63. The base station of claim 62, wherein the message comprises a Neighbor Advertisement (MOB_NBR-ADV) message.

64. The base station of claim 62, wherein the location of the MS comprises Global Positioning System (GPS) coordinates.

65. The base station of claim 62, wherein the means for selecting the one or more neighbor BS candidates is configured to calculate distances between locations for the plurality of neighbor base stations and the location of the MS and to group into the one or more neighbor BS candidates any of the plurality of base stations with a distance to the location of the MS less than a threshold.

66. The base station of claim 65, wherein the locations for the plurality of neighbor base stations comprise Global Positioning System (GPS) coordinates.

67. The base station of claim 62, wherein the location of the MS is a future location of the MS based on a velocity vector and a current location of the MS.

68. The base station of claim 62, wherein the information comprises a location for each of the one or more neighbor BS candidates.

69. A method for determining priority of neighbor base station candidates for a mobile station (MS) to scan or handover, comprising:
obtaining information about a plurality of neighbor base stations (BSs), the information including a location for each of the plurality of neighbor BSs; and
prioritizing the plurality of neighbor BSs to scan or handover based on distances between the location for each of the plurality of neighbor BSs and a location of the MS.

70. The method of claim 69, wherein obtaining the information comprises receiving a Neighbor Advertisement (MOB_NBR-ADV) message having the information, including the location for each of the plurality of neighbor BSs.

71. The method of claim 69, further comprising determining the location of the MS using the Global Positioning System (GPS).

72. The method of claim 71, wherein determining the location of the MS comprises communicating with a GPS device external to the MS.

73. The method of claim 69, wherein the location of the MS is a future location of the MS based on a velocity vector and a current location of the MS.

74. The method of claim 69, wherein prioritizing the plurality of neighbor BSs comprises:
based on the location of the MS, selecting a subset of the plurality of neighbor BSs; and
prioritizing the subset to scan or handover based on distances between the location for each of the plurality of neighbor BSs in the subset and the location of the MS.

75. The method of claim 74, wherein selecting the subset comprises:
calculating distances between the location for each of the plurality of neighbor BSs and the location of the MS; and
grouping into the subset any of the plurality of base stations with a distance to the location of the MS less than a threshold.

76. The method of claim 69, further comprising scanning for at least one of the prioritized plurality of neighbor BSs.

77. The method of claim 69, further comprising triggering a handover based on a distance between the location of the MS and a location of one of the prioritized plurality of neighbor BSs.

78. The method of claim 69, wherein obtaining the information comprises learning the information, including the location for each of the plurality of neighbor BSs, during normal operations.

79. The method of claim 69, wherein obtaining the information comprises receiving a table matching the location for each of the plurality of neighbor BSs to a remaining portion of the information about each of the plurality of neighbor BSs.

80. The method of claim 79, further comprising updating the table by replacing the table, adding at least one new entry to the table, deleting at least one existing entry from the table, or modifying the at least one existing entry.

81. The method of claim 69, wherein prioritizing the plurality of neighbor BSs comprises prioritizing the plurality of neighbor BSs to scan or handover based on a movement direction of the MS and the distances between the location for each of the plurality of neighbor BSs and the location of the MS.

82. A computer-program product for determining priority of neighbor base station candidates for a mobile station (MS) to scan or handover, comprising a computer-readable medium having instructions stored thereon, the instructions being executable by one or more processors and the instructions comprising:
instructions for obtaining information about a plurality of neighbor base stations (BSs), the information including a location for each of the plurality of neighbor BSs; and
instructions for prioritizing the plurality of neighbor BSs to scan or handover based on distances between the location for each of the plurality of neighbor BSs and a location of the MS.

83. The computer-program product of claim 82, wherein the instructions for obtaining the information comprise instructions for receiving a Neighbor Advertisement (MOB_NBR-ADV) message having the information, including the location for each of the plurality of neighbor BSs.

84. The computer-program product of claim 82, further comprising instructions for determining the location of the MS using the Global Positioning System (GPS).

85. The computer-program product of claim 84, wherein the instructions for determining the location of the MS comprises instructions for communicating with a GPS device external to the MS.

86. The computer-program product of claim 82, wherein the location of the MS is a future location of the MS based on a velocity vector and a current location of the MS.

87. The computer-program product of claim 82, wherein the instructions for prioritizing the plurality of neighbor BSs comprise:
instructions for selecting a subset of the plurality of neighbor BSs based on the location of the MS; and
instructions for prioritizing the subset to scan or handover based on distances between the location for each of the plurality of neighbor BSs in the subset and the location of the MS.

88. The computer-program product of claim 87, wherein the instructions for selecting the subset comprise:
instructions for calculating distances between the location for each of the plurality of neighbor BSs and the location of the MS; and
instructions for grouping into the subset any of the plurality of base stations with a distance to the location of the MS less than a threshold.

89. The computer-program product of claim 82, the instructions further comprising instructions for scanning for at least one of the prioritized plurality of neighbor BSs.

90. The computer-program product of claim 82, the instructions further comprising instructions for triggering a handover based on a distance between the location of the MS and a location of one of the prioritized plurality of neighbor BSs.

91. The computer-program product of claim 82, wherein the instructions for obtaining the information comprise instructions for learning the information, including the location for each of the plurality of neighbor BSs, during normal operations.

92. The computer-program product of claim 82, wherein the instructions for obtaining the information comprise instructions for receiving a table matching the location for each of the plurality of neighbor BSs to a remaining portion of the information about each of the plurality of neighbor BSs.

93. The computer-program product of claim 92, the instructions further comprising instructions for updating the table by replacing the table, adding at least one new entry to the table, deleting at least one existing entry from the table, or modifying the at least one existing entry.

94. The computer-program product of claim 82, wherein the instructions for prioritizing the plurality of neighbor BSs comprise instructions for prioritizing the plurality of neighbor BSs to scan or handover based on a movement direction of the MS and the distances between the location for each of the plurality of neighbor BSs and the location of the MS.

95. An apparatus for determining priority of neighbor base station candidates for a mobile station (MS) to scan or handover, comprising:
means for obtaining information about a plurality of neighbor base stations (BSs), the information including a location for each of the plurality of neighbor BSs; and
means for prioritizing the plurality of neighbor BSs to scan or handover based on distances between the location for each of the plurality of neighbor BSs and a location of the MS.

96. The apparatus of claim 95, wherein the means for obtaining the information comprise means for receiving a Neighbor Advertisement (MOB_NBR-ADV) message having the information, including the location for each of the plurality of neighbor BSs.

97. The apparatus of claim 95, further comprising means for determining the location of the MS using the Global Positioning System (GPS).

98. The apparatus of claim 97, wherein the means for determining the location of the MS comprise a GPS device external to the MS.

99. The apparatus of claim 95, wherein the location of the MS is a future location of the MS based on a velocity vector and a current location of the MS.

100. The apparatus of claim 95, wherein the means for prioritizing the plurality of neighbor BSs are configured to select a subset of the plurality of neighbor BSs based on the location of the MS and to prioritize the subset to scan or handover based on distances between the location for each of the plurality of neighbor BSs in the subset and the location of the MS.

101. The apparatus of claim 100, wherein the means for selecting the subset are configured to calculate distances between the location for each of the plurality of neighbor BSs and the location of the MS and to group into the subset any of the plurality of base stations with a distance to the location of the MS less than a threshold.

102. The apparatus of claim 95, further comprising means for scanning for at least one of the prioritized plurality of neighbor BSs.

103. The apparatus of claim 95, further comprising means for triggering a handover based on a distance between the location of the MS and a location of one of the prioritized plurality of neighbor BSs.

104. The apparatus of claim 95, wherein the means for obtaining the information are configured to learn the information, including the location for each of the plurality of neighbor BSs, during normal operations.

105. The apparatus of claim 95, wherein the means for obtaining the information are configured to receive a table matching the location for each of the plurality of neighbor BSs to a remaining portion of the information about each of the plurality of neighbor BSs.

106. The apparatus of claim 105, further comprising means for updating the table configured to replace the table, add at least one new entry to the table, delete at least one existing entry from the table, or modify the at least one existing entry.

107. The apparatus of claim 95, wherein the means for prioritizing the plurality of neighbor BSs comprise means for prioritizing the plurality of neighbor BSs to scan or handover based on a movement direction of the MS and the distances between the location for each of the plurality of neighbor BSs and the location of the MS.

108. A mobile device, comprising:
collecting logic configured to obtain information about a plurality of neighbor base stations (BSs), the information including a location for each of the plurality of neighbor BSs; and
prioritizing logic configured to prioritize the plurality of neighbor BSs to scan or handover based on distances between the location for each of the plurality of neighbor BSs and a location of the mobile device.

109. The mobile device of claim 108, wherein the collecting logic is configured to receive a Neighbor Advertisement (MOB_NBR-ADV) message having the information, including the location for each of the plurality of neighbor BSs.

110. The mobile device of claim 108, further comprising locating logic configured to determine the location of the mobile device using the Global Positioning System (GPS).

111. The mobile device of claim 110, wherein the locating logic is configured to communicate with a GPS device external to the MS.

112. The mobile device of claim 108, wherein the location of the mobile device is a future location of the mobile device based on a velocity vector and a current location of the mobile device.

113. The mobile device of claim 108, wherein the prioritizing logic is configured to select a subset of the plurality of neighbor BSs based on the location of the mobile device and to prioritize the subset to scan or handover based on distances between the location for each of the plurality of neighbor BSs in the subset and the location of the mobile device.

114. The mobile device of claim 113, wherein the prioritizing logic is configured to select the subset by calculating distances between the location for each of the plurality of neighbor BSs and the location of the mobile device and by grouping into the subset any of the plurality of base stations with a distance to the location of the mobile device less than a threshold.

115. The mobile device of claim 108, further comprising scanning logic configured to scan for at least one of the prioritized plurality of neighbor BSs.

116. The mobile device of claim 108, further comprising triggering logic configured to trigger a handover based on a distance between the location of the mobile device and a location of one of the prioritized plurality of neighbor BSs.

117. The mobile device of claim 108, wherein the collecting logic is configured to learn the information, including the location for each of the plurality of neighbor BSs, during normal operations.

118. The mobile device of claim 108, wherein the collecting logic is configured to receive a table matching the location for each of the plurality of neighbor BSs to a remaining portion of the information about each of the plurality of neighbor BSs.

119. The mobile device of claim 118, wherein the collecting logic is configured to update the table by replacing the table, to add at least one new entry to the table, to delete at least one existing entry from the table, or to modify the at least one existing entry.

120. The mobile device of claim 108, wherein the prioritizing logic is configured to prioritize the plurality of neighbor BSs to scan or handover based on a movement direction of the mobile device and the distances between the location for each of the plurality of neighbor BSs and the location of the mobile device.

121. A method for advertising a plurality of neighbor base stations (BSs), comprising:
obtaining information about the plurality of neighbor BSs, the information including a location for each of the plurality of neighbor BSs; and
transmitting a message comprising the information.

122. The method of claim 121, wherein the message comprises a Neighbor Advertisement (MOB_NBR-ADV) message.

123. The method of claim 121, wherein the location for each of the plurality of neighbor BSs comprises Global Positioning System (GPS) coordinates.

124. The method of claim 121, wherein obtaining the information including the location for each of the plurality of neighbor BSs comprises receiving the information via a network backbone.

125. The method of claim 121, further comprising:
updating the information about the plurality of neighbor BSs; and
transmitting a new message comprising the updated information.

126. The method of claim 125, wherein updating the information comprises adding information for a new base station added to the plurality of neighbor BSs or removing information for one of the plurality of neighbor BSs removed from the plurality.

127. A computer-program product for advertising a plurality of neighbor base stations (BSs), comprising a computer-readable medium having instructions stored thereon, the instructions being executable by one or more processors and the instructions comprising:
instructions for obtaining information about the plurality of neighbor BSs, the information including a location for each of the plurality of neighbor BSs; and
instructions for transmitting a message comprising the information.

128. The computer-program product of claim 127, wherein the message comprises a Neighbor Advertisement (MOB_NBR-ADV) message.

129. The computer-program product of claim 127, wherein the location for each of the plurality of neighbor BSs comprises Global Positioning System (GPS) coordinates.

130. The computer-program product of claim 127, wherein the instructions for obtaining the information including the location for each of the plurality of neighbor BSs comprise instructions for receiving the information via a network backbone.

131. The computer-program product of claim 127, the operations further comprising:
instructions for updating the information about the plurality of neighbor BSs; and
instructions for transmitting a new message comprising the updated information.

132. The computer-program product of claim 131, wherein the instructions for updating the information comprise instructions for adding information for a new base station added to the plurality of neighbor BSs or instructions for removing information for one of the plurality of neighbor BSs removed from the plurality.

133. An apparatus for advertising a plurality of neighbor base stations (BSs), comprising:
means for obtaining information about the plurality of neighbor BSs, the information including a location for each of the plurality of neighbor BSs; and
means for transmitting a message comprising the information.

134. The apparatus of claim 133, wherein the message comprises a Neighbor Advertisement (MOB_NBR-ADV) message.

135. The apparatus of claim 133, wherein the location for each of the plurality of neighbor BSs comprises Global Positioning System (GPS) coordinates.

136. The apparatus of claim 133, wherein the means for obtaining the information including the location for each of the plurality of neighbor BSs is configured to receive the information via a network backbone.

137. The apparatus of claim 133, further comprising:
means for updating the information about the plurality of neighbor BSs; and
means for transmitting a new message comprising the updated information.

138. The apparatus of claim 137, wherein the means for updating the information is configured to add information for a new base station added to the plurality of neighbor BSs or to remove information for one of the plurality of neighbor BSs removed from the plurality.

139. A base station, comprising:
logic configured to obtain information about the plurality of neighbor base station (BSs), the information including a location for each of the plurality of neighbor BSs; and
a transmitter configured to transmit a message comprising the information.

140. The base station of claim 139, wherein the message comprises a Neighbor Advertisement (MOB_NBR-ADV) message.

141. The base station of claim 139, wherein the location for each of the plurality of neighbor BSs comprises Global Positioning System (GPS) coordinates.

142. The base station of claim 139, wherein the logic is configured to receive the information, including the location for each of the plurality of neighbor BSs, via a network backbone.

143. The base station of claim 139, wherein the logic is configured to update the information about the plurality of neighbor BSs and the transmitter is configured to transmit a new message comprising the updated information.

144. The base station of claim 143, wherein the logic is configured to update the information by adding information for a new base station added to the plurality of neighbor BSs or by removing information for one of the plurality of neighbor BSs removed from the plurality.
